(19) United States
(12) Patent Application Publication
(10) Pub. No.: US 2021/0097879 A1
(43) Pub. Date: Apr. 1, 2021

(54) SYSTEM AND METHOD FOR TEST AND STUDY ADMINISTRATION AND EVALUATION

(71) Applicant: Induction Learning LLC., Evanston, IL (US)

(72) Inventors: Joshua Zabar Breite, NEW YORK, NY (US); Benjamin Altschuler, NEW YORK, NY (US)

(21) Appl. No.: 17/032,636

(22) Filed: Sep. 25, 2020

Related U.S. Application Data
(60) Provisional application No. 62/906,903, filed on Sep. 27, 2019.

(51) Int. Cl. G09B 7/06; G09B 7/02

(52) U.S. Cl. CPC G09B 7/06; G09B 7/02

(57) ABSTRACT

A testing and study administration system is provided for administering a test to a user having an input module, the input module configured to receive communications from the user for a test selection, and test answers from the user. A central server is configured to store one or more available tests, and to administer the selected test among the one or more available tests to the user. A computing device is configured to monitor at least one behavior of the user, when taking the selected test, the computing device further configured to analyze the at least one monitored behavior and generate a feedback for the user. An output module is configured to provide the generated feedback to the user during continued administration of the selected test, the output module having a custom test generator that generates at least a second practice test with different questions than the selected test generated feedback.

### RELATED APPLICATION

This application claims the benefit of priority from U.S. Provisional Application No. 62/906,903, filed on Sep. 27, 2019, the entirety of which is incorporated by reference.

### FIELD OF THE INVENTION

This invention relates to a system and method for administering testing and studying. More particularly, this invention relates to a system and method for administering tests with active feedback and modification.

### DESCRIPTION OF RELATED ART

In the area of automated and on-line testing platforms there are several testing platforms that exist as computer implemented tests r where the user fills in bubble sheet by clicking in bubbles on the computer. Khan Academy™ and Test Innovators™ are examples. Such services break tests up into different categories and grade the user's tests. After a user completes an exam, they get a score report of the that exam. Even though the test is taken on the computer there is a lot of data about the user's mannerisms, actions, test taking habits, and other actions they take during the exam that is lost, which could otherwise be helpful to tailor tests and test analysis to the user's particular needs.

### OBJECTS AND SUMMARY

The present arrangement is directed to a system and method to implement test and study administration and evaluation. For example, in one implementation, the present arrangement can be used to administering testing to individual and provide real-time feedback to the individual, including but not limited to monitoring and analysis of the test/individual during the test taking procedure, prompting of the individual during the test for study aids, modification/tailoring of the test in real-time to better address induvial weakness, post-test analysis and other related features as described in more detail herein.

To this end, a testing and study administration system is provided for administering a test to a user having an input module, the input module configured to receive communications from the user for a test selection, and test answers from the user. A central server is configured to store one or more available tests, and to administer the selected test among the one or more available tests to the user. A computing device is configured to monitor at least one behavior of the user, when taking the selected test, the computing device further configured to analyze the at least one monitored behavior and generate a feedback for the user. An output module is configured to provide the generated feedback to the user during continued administration of the selected test, the output module having a custom test generator that generates at least a second practice test with different questions than the selected test generated feedback.

### BRIEF DESCRIPTION OF THE DRAWINGS:

The present invention can be best understood through the following description and accompanying drawing, wherein:

FIG. 1 illustrates a test and study administration system, in accordance with one embodiment;

FIG. 2 illustrates an input module of the test and study administration system of FIG. 1, in according with one embodiment;

FIG. 3 illustrates a central server of the test and study administration system of FIG. 1, in according with one embodiment;

FIG. 4 illustrates a computing device of the test and study administration system of FIG. 1, in according with one embodiment;

FIG. 5 illustrates an output module of the test and study administration system of FIG. 1, in according with one embodiment;

FIG. 6 is a flow diagram for at least one process implemented on the test and study administration system, in accordance with one embodiment;

FIG. 7 is a flow diagram for at least one process implemented on the test and study administration system, in accordance with one embodiment;

FIG. 8 is a flow diagram for at least one process implemented on the test and study administration system, in accordance with one embodiment;

FIG. 9 is a flow diagram for at least one process implemented on the test and study administration system, in accordance with one embodiment;

FIG. 10 is a flow diagram for at least one process implemented on the test and study administration system, in accordance with one embodiment;

FIG. 11 is a flow diagram for at least one process implemented on the test and study administration system, in accordance with one embodiment;

FIG. 12 is a flow diagram for at least one process implemented on the test and study administration system, in accordance with one embodiment;

FIG. 13 is a flow diagram for at least one process implemented on the test and study administration system, in accordance with one embodiment;

FIG. 14 is a flow diagram for at least one process implemented on the test and study administration system, in accordance with one embodiment;

FIG. 15 is a flow diagram for at least one process implemented on the test and study administration system, in accordance with one embodiment;

FIG. 16 is a flow diagram for at least one process implemented on the test and study administration system, in accordance with one embodiment;

FIG. 17 is a flow diagram for at least one process implemented on the test and study administration system, in accordance with one embodiment;

FIG. 18 is a flow diagram for at least one process implemented on the test and study administration system, in accordance with one embodiment;

FIG. 19 is a flow diagram for at least one process implemented on the test and study administration system, in accordance with one embodiment;

FIG. 20 is a flow diagram for at least one process implemented on the test and study administration system, in accordance with one embodiment;

FIG. 21 is a flow diagram for at least one process implemented on the test and study administration system, in accordance with one embodiment;

FIG. 22 is a flow diagram for at least one process implemented on the test and study administration system, in accordance with one embodiment;

FIG. 23 is a flow diagram for at least one process implemented on the test and study administration system, in accordance with one embodiment;

FIG. 24 is a flow diagram for at least one process implemented on the test and study administration system, in accordance with one embodiment;

FIG. 25 is a flow diagram for at least one process implemented on the test and study administration system, in accordance with one embodiment;

FIG. 26 is a flow diagram for at least one process implemented on the test and study administration system, in accordance with one embodiment;

FIG. 27 is a flow diagram for at least one process implemented on the test and study administration system, in accordance with one embodiment;

FIG. 28 is a flow diagram for at least one process implemented on the test and study administration system, in accordance with one embodiment;

FIG. 29 is a flow diagram for at least one process implemented on the test and study administration system, in accordance with one embodiment;

FIG. 30 is a flow diagram for at least one process implemented on the test and study administration system, in accordance with one embodiment;

FIG. 31 is a flow diagram for at least one process implemented on the test and study administration system, in accordance with one embodiment; and

FIG. 32 is a flow diagram for at least one process implemented on the test and study administration system, in accordance with one embodiment.

### DETAILED DESCRIPTION:

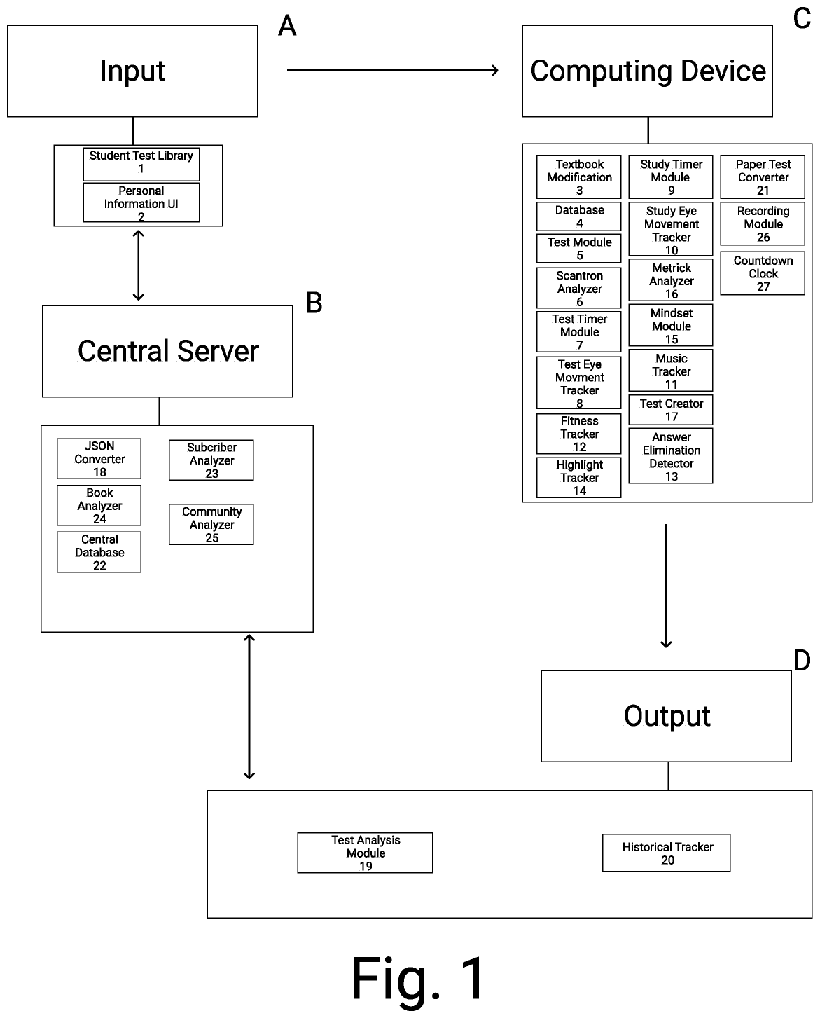

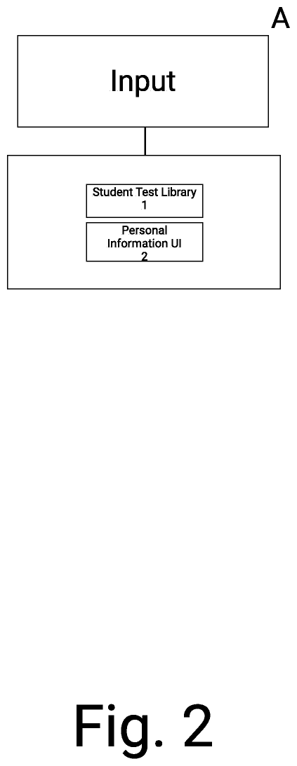

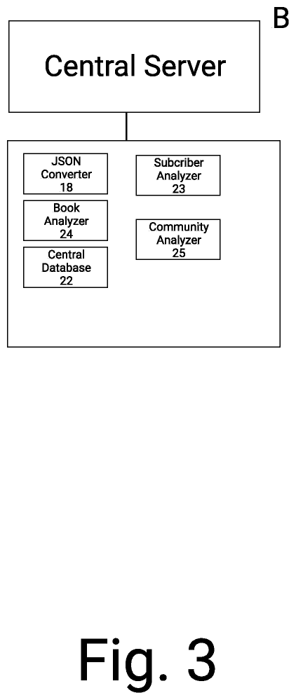

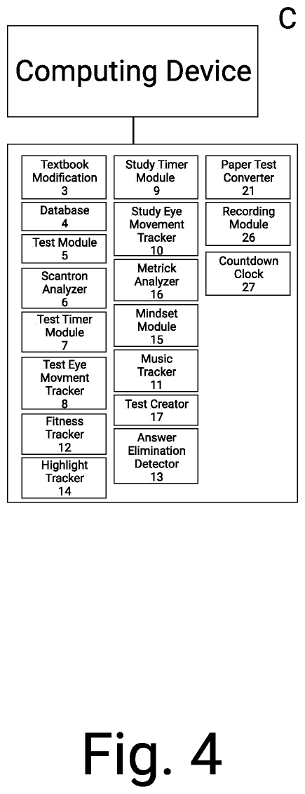

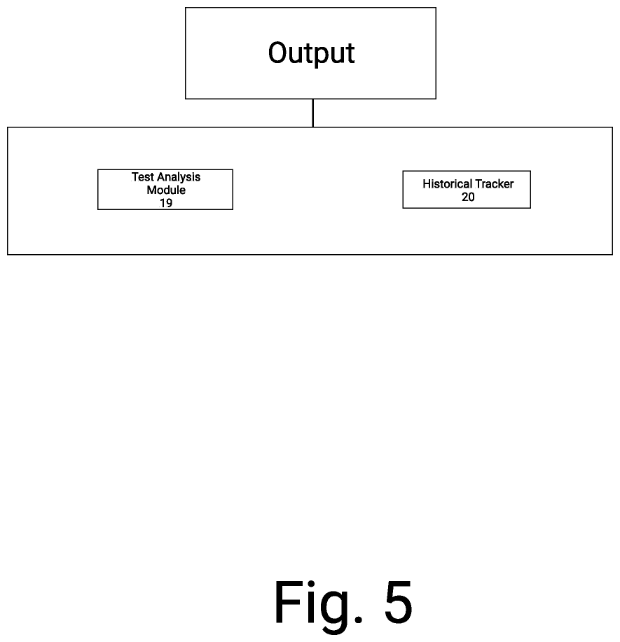

In one exemplary implementation, FIG. 1 shows an overview of a testing and study administration system, including an input module A, a central server B, a computing device C and an output module D and their relationship with one another. FIGS. 2-5 show each of such modules A-D individually. It is understood that these characterizations of such modules are intended as exemplary only, and that the present system may be implemented with other combinations of modules as needed to support the salient features of the invention.

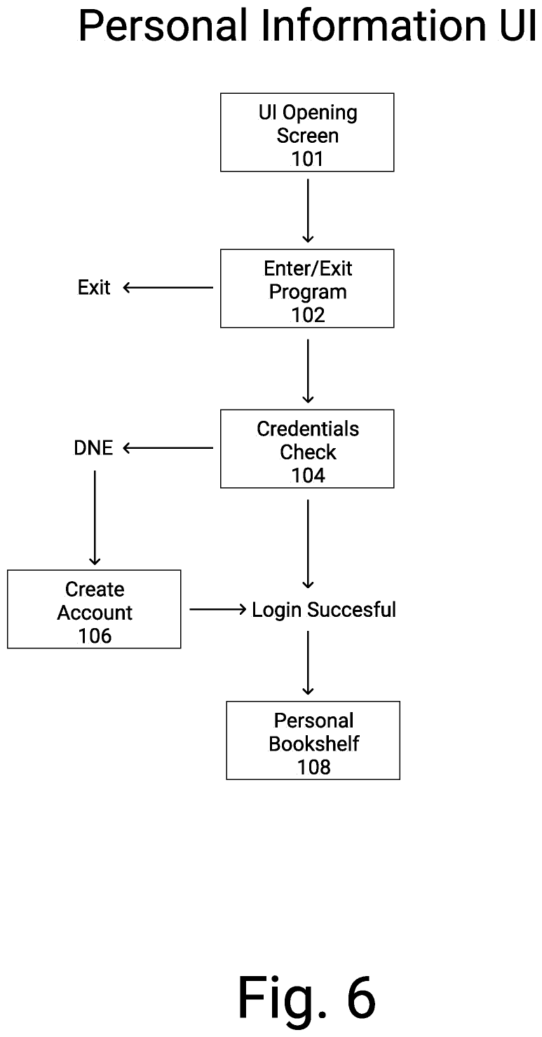

Such input module A, computing device C, central server B and output module D, and each of the subcomponents illustrated in FIGS. 1-5 are used in implementing a testing and study analysis in accordance with a series steps/processes shown in FIGS. 6-32 described in more detail below. The following short list of elements 1-27 (system components) and 100-236 (stages) that represent a brief overview of the various elements and stages/steps implemented in the preferred embodiments of the present testing system.

| Elements | # | Definition |
|---|---|---|
| User Test | 1 | The user's test(s) that he has downloaded to his device. The user will get |
| Library | | their given study or tests from their own personal device, downloading it |
| | | themselves. |
| Personal | 2 | User signs into the application and gives personal information that is stored in the |
| Information | | database, identifying each user. |
| UI | | |
| Textbook | 3 | Go through and correlate to JSON files to make this an overlay an Enhanced E- |
| Modification | | Textbook (120). |
| Module | | |
| Database | 4 | The Database (4) is where all the information will be stored from the Scantron |
| Module | | Analyzer (6), Test Timer Module (7), Test Eye Movement Tracker (8), Study Timer |
| | | Module (9), Study Eye Movement Tracker (10), Music Tracker (11), Fitness |
| | | Tracker (12), Answer Elimination Detector (13), Highlight Tracker (14), Mindset |
| | | Module (15), Metric Analyzer (16), Test Creator (17), and Recording Module (26). |
| Test Module | 5 | User takes a test in this module and all steps that are needed to happen on the device |
| | | are activated (shown in the test module). |
| Scantron | 6 | Test is graded after the test end by comparing to the JSON files (122) to see |
| Analyzer | | how the User scored on given exam. |
| Test Timer | 7 | The timer that is run while a practice test is being performed on the application. |
| Module | | |
| Test Eye | 8 | Tracks the Users' eye movement and where they are looking, while the test |
| Movement | | module is being used. |
| Tracker | | |
| Study Timer | 9 | The timer that is run while a user is using the study module. |
| Moule | | |
| Study Eye | 10 | Tracks the users' eye movement and where they are looking, while the |
| Movement | | study module is being used. |
| Tracker | | |
| Music | 11 | Correlates how a user does while studying with what music they are |
| Tracker | | listening to on the device. |
| Fitness | 12 | Correlates how a user does while studying with their wearable device while |
| Tracker | | they are in the study module or test module. |
| Answer | 13 | Answer Elimination Detector (13) will be used to see the user's process through the |
| Elimination | | test and how close they are to narrowing down to the right question by tracking |
| Detector | | which questions they cross out. |
| Highlight | 14 | Tracks the percentage the user highlights a particular passage or question |
| Tracker | | with their writing. |
| Mindset | 15 | Tests users' anxiety before and after tests as well as get information about |
| Module | | the user, which is stored in the database |
| Metric | 16 | Database (4) syncs with the Question ID (188) to create metrics (190) listed inside |
| Analyzer | | appendix. |
| Test Creator | 17 | The user gets a choice of personalized tests consisting of Question Compiler (202), |
| | | taking from the other books on their Personal Bookshelf (108). |
| JSON | 18 | Books, tests, and study will be converted to JSON files including information |
| Converter | | that is needed to created Enhanced E-Textbook (120). |
| Test Analysis | 19 | Metric Analyzer (16) will put into Data Organizer (206) where the device produces |
| Module | | Tables (208), Charts (210), and Graphs (212) for the user to understand their test |
| | | analysis better. These Tables (208), Charts (210), and Graphs (212) will be sent to |
| | | the Database (4) to be accessed for later use. |
| Historical | 20 | Is used to predict how people do historically based off their final scores and the data |
| Tracker | | from their study. User Input Scores (230) is where the user will add their final score |
| | | to the Database (4). This will go to the Metric Analyzer (16) that will produce |
| | | Tables (208), Charts (210), and Graphs (212). |
| Paper Test | 21 | The Paper Test Input (218) is a test or results taken from an outside source. For |
| Converter | | example, the user could take a SAT practice test and scan in their bubble sheet, so |
| | | the data is stored in the Database (4). |
| Central | 22 | The Central Database (22) is where all information is stored. The Database (4) |
| Database | | tracks individual users' information, which is sent to Central Database (22). All |
| | | bookkeeping function are here. |
| Subscriber | 23 | Users are put in personal information which will be used in the Central |
| Analyzer | | Database (22) so users' study and tests can be sorted |
| Book | 24 | Create “True” curve of the test based on the scores from every test take in the |
| Analyzer | | Curving System (220). |
| Community | 25 | The Central Database (22) will use the individual user's data to compile |
| Analyzer | | Community (214) statistics that represent the Metric Analyzer (16) statistics, but for |
| | | how the entire community did on the test. |
| Recording | 26 | While in the test module, the users' writing is recorded so user can look |
| Module | | back at their work for later use. |
| Countdown | 27 | The Countdown Clock will serve to help a user's study by training them how long |
| Clock | | to take for a given question. |
| UI | 100 | User Interface Component of Textbook, representing a user inside the book |
| Component | | in a general area |
| UI Opening | 101 | This is the page the user will first see when they open the application, |
| Screen | | prompting a check of their credentials. |
| Enter/Exit | 102 | The user will have the option to continue to next part of program or exit to |
| Program | | UI Opening Screen by pressing this button |
| Credentials | 104 | This step will check if the login details match up with an account that has |
| Check | | previously been used or if that user must be redirected to make a new |
| | | account |
| Create | 106 | Create account will allow the user to create a username and password that |
| Account | | will identify the user throughout their use of the application and separate |
| | | their data from other users |
| Personal | 108 | The personal bookshelf is the user's books that they own from the |
| Bookshelf | | Bookstore |
| Add Book | 110 | This button redirects learners to the bookstore so they can purchase books, |
| Button | | thus, adding them to their personal bookshelf |
| Bookstore | 112 | The Bookstore is the database of books that a learner can add to their |
| | | personal bookshelf through purchasing the book. The books will be, but not |
| | | limited to the Official College Board SAT Book, Princeton Review US History |
| | | II, MCAT, Geometry Textbook, etc. |
| Owner of | 114 | Once the user purchases a book then they will own that book, so it will |
| Book | | show up on their personal bookshelf, giving them full access to the book |
| Buy Button | 116 | Once in the bookstore, if a user does not own a book, they will use the buy |
| | | button on the display to purchase a book |
| Book | 118 | Book is any book that is available from the Bookstore. |
| Enhanced E- | 120 | Enhanced E-Textbook features include, Database, Test Module, Scantron |
| Textbook | | Analyzer, Test Timer Module, Test Eye Movement Tracker, Study Timer |
| | | Module, Study Eye Movement Tracker, Music Tracker, Fitness Tracker, |
| | | Answer Elimination Detector, Highlight Tracker, Mindset Module, Metric |
| | | Analyzer, Test Creator, and Recording Module. After this the book will |
| | | overlay an Enhanced E-Textbook. |
| JSON File | 122 | will codify all the information of a given test answers already in the book |
| | | such as test type, correct answer, category, subcategory, and answer |
| | | strength. For example, the JSON File will recognize that the user is using a |
| | | Princeton Review Book and have the information for each individual |
| | | question throughout the book. It will know that question 3 is in the math |
| | | section, its subcategory is linear algebra, the answer is A, and it will have |
| | | the explanation. This also applies to general school textbooks. |
| UI Test Page | 124 | As a user is scrolling through their book the UI Test Page is the starting |
| | | point of a practice test in a given book |
| Start Test | 128 | To start the test they will press this button on the UI Test Page |
| Button | | |
| Disable | 130 | Functionality when the Test is in Progress that does not allow the tablet to |
| Sleep | | have the screen go off |
| Answer | 132 | Answer sheet (teacher customized or bubble sheet) will become available |
| Sheet | | |
| Emulator | | |
| Screen Lock | 134 | Tablet will not let you leave the app The Answer Sheet Emulator brings up |
| | | the bubble sheet required for standardized tests. |
| Connection | 138 | Connection Cut will make sure that the device is not connected to WIFI or |
| Cut | | Cellular during the test. |
| Test in | 142 | When the test is active, and the users is actively doing the test itself |
| Progress | | |
| Section | 144 | Section of that particular test has come to an end, temporarily cutting off |
| Finish | | testing modules |
| Section End | 148 | User can end the section before the timer ends by pressing the Section End |
| Button | | button, which will finish that particular section |
| Test End | 150 | After all sections are over the Test Ends |
| Fill in | 152 | Fill in an answer on the bubble sheet or whatever the teacher has provided |
| Answer | | ie. a fill in the blank |
| Sort | 154 | Deciding what type of question asked on the JSON File that particular |
| Question | | question is classified as. For example, it could be a linear algebra question |
| | | from a math section, integration prob from a Calculus book, or American |
| | | History question from a History textbook. |
| Right or | 156 | Is the function that dictates whether the learner got that question right or |
| Wrong | | wrong |
| Timer Starts | 158 | Function that dictates that the timer for that action starts. For example, the |
| | | timer could start from the test section or time spent on that page etc. |
| Timer Ends | 160 | Function that dictates that the timer for that action ends. For example, the |
| | | timer could end from the test section or time spent on that page etc. |
| Engage | 162 | When a user writes on the question's designated area box that is drawn by |
| Question | | a computer program |
| Eye Reader | 164 | Functionality of the eye reader turns on and starts tracking movement of |
| Engages | | the learner's eyes. This tracks the eye movement of time on question time |
| | | on passage, time on answer sheet, time on instructions, etc. |
| Scroll over | 166 | Textbook will recognize the section that the user is studying and store that |
| Recognized | | in the database. It could be a math section, English section, geometry, or |
| Section | | commas |
| Engage Book | 168 | Writes in the book using finger or stylus. |
| Done Study | 170 | Button that is pressed on the display, which tells the program that user has |
| Button | | stopped studying for that period |
| Circle | 172 | When a user physically circles an answer with their finger or stylus leaving a |
| Answer | | circle around that answer |
| Exercise End | 174 | Button that is pressed on the display that tells the program when the |
| Button | | learner has finished the exercise, they are studying in the book |
| Music | 176 | This function recognizes if music is playing, while a learner is studying |
| Playing | | |
| Music Type | 178 | Recognizes what type of music is playing including, album, artist, and song. |
| User Fitness | 180 | Is what will be tracking the user's mindfulness, steps, and heart rate. For |
| Tracker | | example, an Apple Watch will track this, and that data will be tracked. |
| “X” out | 182 | The “X” denotes an answer null when the learner has either circled or filled |
| Answer | | in an answer on the test or answer sheet |
| Amount | 184 | Shows the percentage of how much a learner has drawn on a particular |
| Drawn On | | section, question, or passage. |
| Mindset Test | 186 | Test designed to study the mindset of the user before study or testing |
| Question ID | 188 | Identifies where the question is from and what it is. I.e. what test is it from, |
| | | what number in that test, what section, and what subcategory. |
| Test Creator | 190 | Button on display that takes the user to the Test Type Menu. A one test |
| Button | | minimum is needed to use this feature |
| Test Type | 192 | The learner will get a choice of personalized tests consisting of Question |
| Menu | | Compiler, taking from the other books on their Personal Bookshelf. |
| Inverse | 194 | Test that gives people question with the inverse scores of their subject |
| Subject | | scores. They will get questions in categories where they have performed |
| | | poorly on tests. For example, if they have done poor on Linear algebra |
| | | question then the program will collect linear algebra questions from their |
| | | library to create another test. |
| Slow Right | 196 | Test that gives people types of questions that they have gotten right on |
| Answers | | tests yet have taken them a long time. For example, if an integration |
| | | problem takes them long, but the user gets it right the program will collect |
| | | integration questions from their library to create another test. |
| Time | 198 | Test that gives people types of questions that they have taken a long time |
| Consuming | | on compared to the average of other test takers. |
| Poor | 200 | Test that gives people types of questions that they have struggled with in a |
| Groupings | | cluster. For example, if they continually get comma questions wrong |
| | | directly after a semi-colon question. |
| Question | 202 | Compiles questions from the books on the learner's personal bookshelf by |
| Compiler | | taking picture of the question |
| UI | 204 | Customized User Test based on the test type they chose from Test Type |
| Personalized | | Menu |
| Test | | |
| Data | 206 | Where the metric analyzer will pass information to make Tables, Charts, |
| Organizers | | and Graphs. |
| Tables | 208 | Tables used to describe learner performance |
| Charts | 210 | Charts used to describe learner performance |
| Graphs | 212 | Graphs used to describe learner performance |
| Community | 214 | Community will be where all information on testing of the same book is |
| | | stored. |
| Personal | 218 | Where the user will fill out his personal information such as name, address, |
| Information | | email address, phone number, school, and age. |
| Entry | | |
| Scan with | 220 | Camera of the tablet will scan the answer sheet and the user's answers will |
| Camera | | be read into the program |
| Curving | 222 | This system will curve tests to their “True Value,” giving users the ability to |
| System | | know what different scores from different books actually mean in |
| | | comparison to final test performance |
| Recorder | 224 | Will recorded the user's writing as they are taking a test |
| Playback | 226 | The playback will be a faint overlay on the test and then once the user |
| | | wants to see their real time writing, they will tell the device to playback the |
| | | recording. |
| User Data | 228 | If the test data is not already in the Database, the user will use the User |
| Entry | | Data Entry to enter basic information about the test such as section, |
| | | subcategory, and answer. |
| User Input | 230 | The user will input their final scores on their test so that the device will be |
| Score | | able to predict how people will do based off their data |
| Combination | 232 | Test that will combine all tests together, testing users on their weaknesses. |
| Countdown | 234 | Mode that will let users have a clock on the questions they perform that |
| Mode | | will serve to help them have a better understanding of how long they |
| | | should spend on each question. |
| Time Picker | 236 | Menu that will show the times that users have top pick from for the |
| | | Countdown Clock. They will have three options: slow, normal, and fast. |

The following is more in-depth review of each of the various test modules and features as shown in FIGS. 6-32 as implemented through test and study administration system and Modules A-D, inclusive of sub-modules 1-27 as illustrated in FIGS. 1-5. It is understood that these characterizations of such modules and sub-routine processes are intended as exemplary, and that the present system may be implemented with any combination thereof as well as with other combinations and processes as needed to support the salient features of the invention.

In one embodiment, FIG. 6 illustrates at least one sub-routine implemented on the present test and study administration system where a user signs into their personal account. The user clicks on the app and sees the UI Opening Screen (101). They can be redirected to an Enter/Exit Program button (102), which prompts a credentials check (104). If they have a username and password, they can login and go to the Personal Bookshelf (108). If not, they can use Create Account (106) to make a username and password to be redirected to their Personal Bookshelf (108).

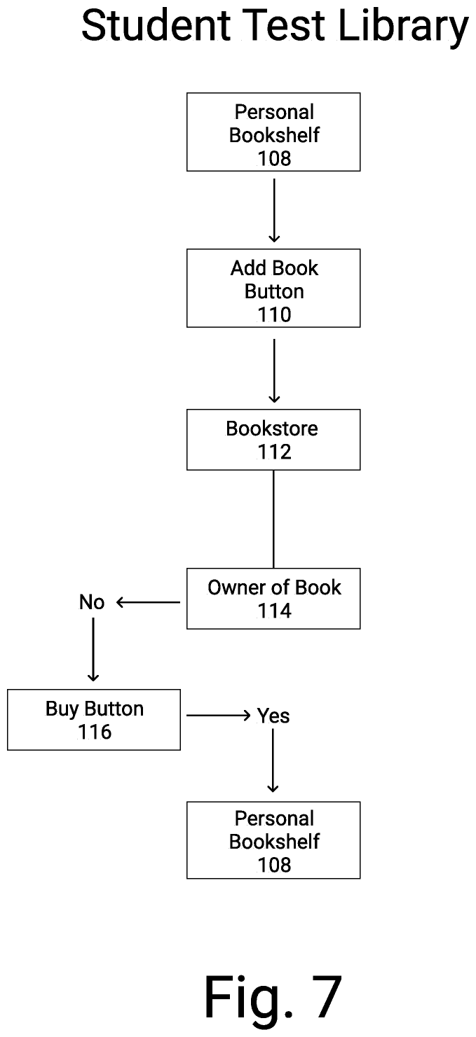

In one embodiment, FIG. 7 illustrates at least one sub-routine implemented on the present test and study administration system where a Personal Bookshelf (108) is displayed, showing what textbooks the user has already downloaded. If the user would like to download another book, they press the add book button (110) on the display, which redirects the user to the bookstore (112) where they see a curated list of books given to them, for example, the Official College Board SAT Book, Princeton Review US History II, MCAT, Geometry Textbook, etc. If they are an owner of the book (114), the book is displayed on the Personal Bookshelf (108). If not, they can click the buy button (116) on the display to get access to the book on their Personal Bookshelf (108). Such a feature and process may be used additionally used to allow users to download their own additional content not limited to formal textbooks or review books, but also including personal notes and other personal documents used for test preparation.

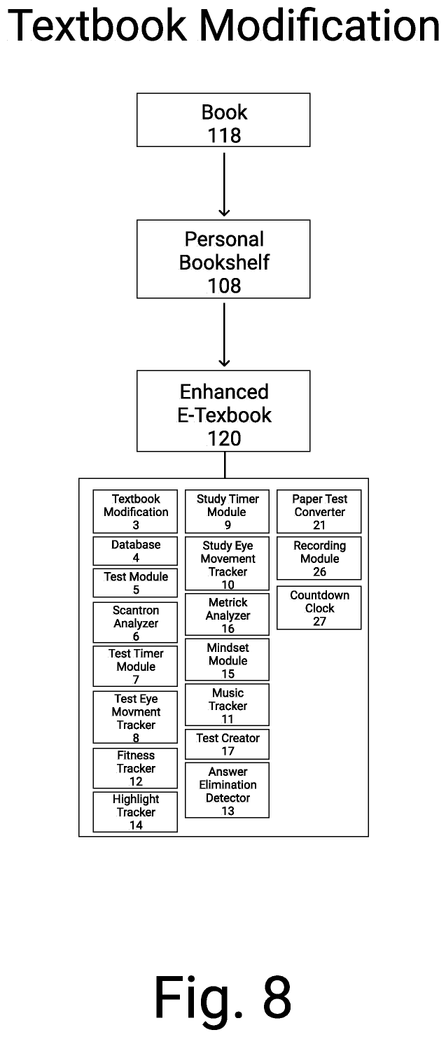

In one embodiment, FIG. 8 illustrates at least one sub-routine implemented on the present test and study administration where, once the Book (118) is on the Personal Bookshelf (108), there may be access to Enhanced E-Textbook (120) features that include, Database (4), Test Module (5), Scantron Analyzer (6), Test Timer Module (7), Test Eye Movement Tracker (8), Study Timer Module (9), Study Eye Movement Tracker (10), Music Tracker (11), Fitness Tracker (12), Answer Elimination Detector (13), Highlight Tracker (14), Mindset Module (15), Metric Analyzer (16), Test Creator (17), and Recording Module (26). After this the book can overlay an Enhanced E-Textbook (120).

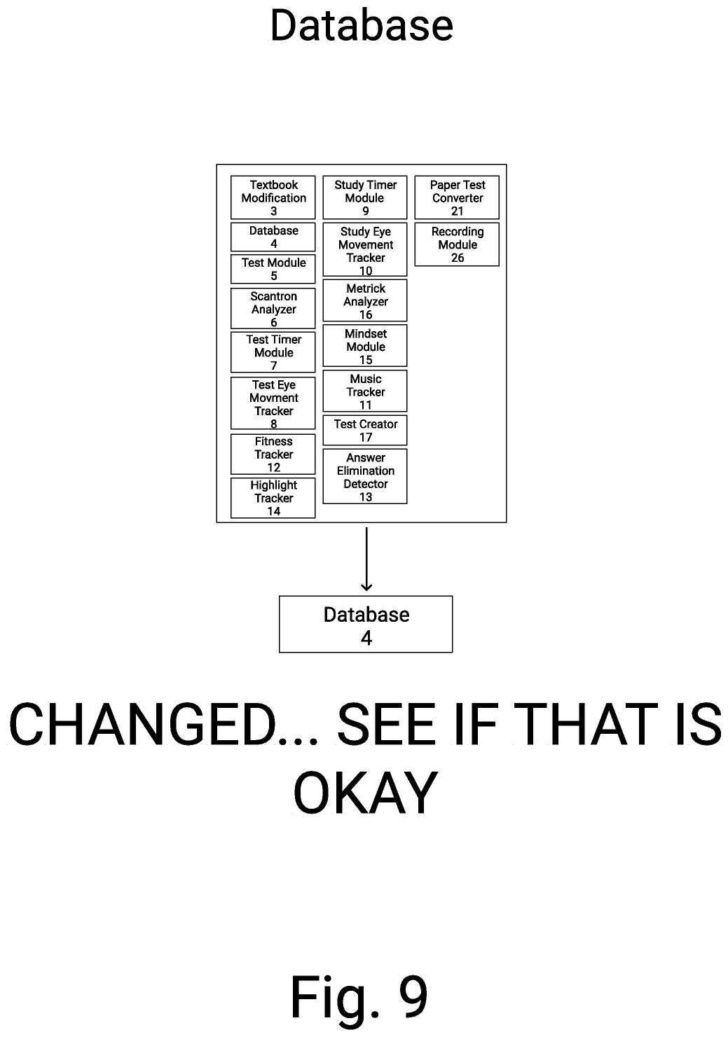

In one embodiment shown in FIG. 9, it is illustrated that Database (4) is where all the information is stored from the Scantron Analyzer (6), Test Timer Module (7), Test Eye Movement Tracker (8), Study Timer Module (9), Study Eye Movement Tracker (10), Music Tracker (11), Fitness Tracker (12), Answer Elimination Detector (13), Highlight Tracker (14), Mindset Module (15), Metric Analyzer (16), Test Creator (17), and Recording Module (26).

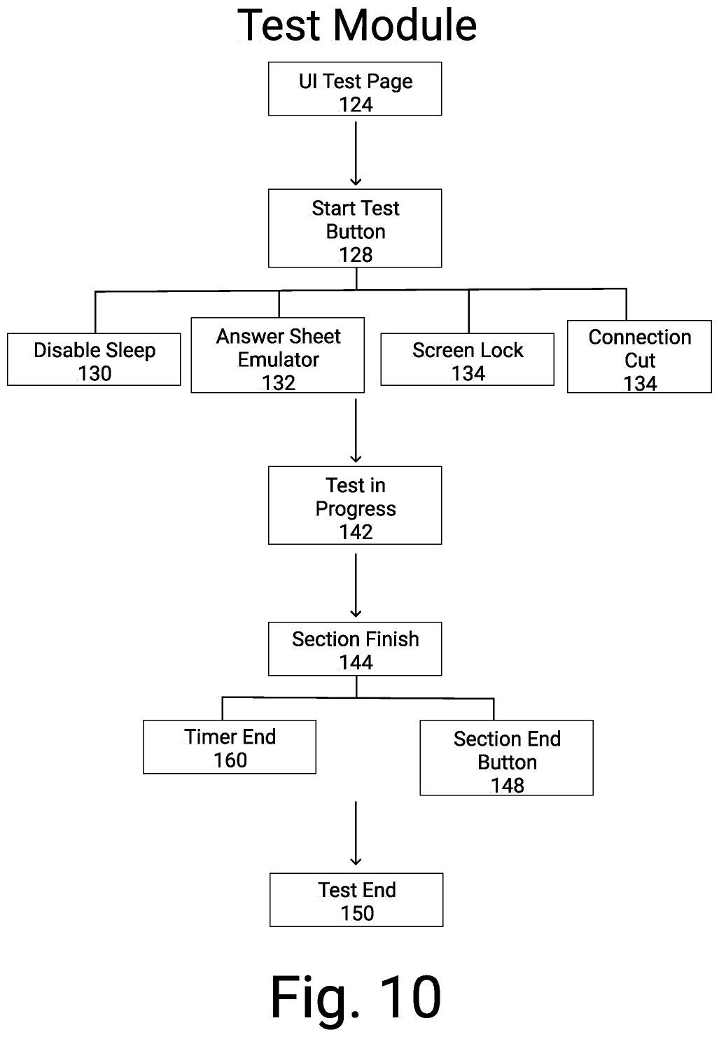

In one embodiment, FIG. 10 illustrates at least one sub-routine implemented on the present test and study administration where test module (5) runs when a practice test is being taken. A user, in their Book (118), scrolls to a designated UI Test Page (124), which is the starting point of a practice test in a given book. The user can press the Start Test Button (128), on the display of the UI Test Page (124). This prompts the tablet to Disable Sleep (130), bring up the Answer Sheet Emulator (132), perform Screen Lock (134), and Connection Cut (138). The Answer Sheet Emulator (132) brings up the bubble sheet required for standardized tests. Screen Lock (134) locks the tablet screen such that the user cannot change apps. Connection Cut (138) makes sure that the device is not connected to Wifi or Cellular during the test. The test is in Test in Progress (142) until the Section Finish (144) happens by the Timer End (160) or Section End Button (148). This process repeats itself until that designated test is done and, thus, Test End (150).

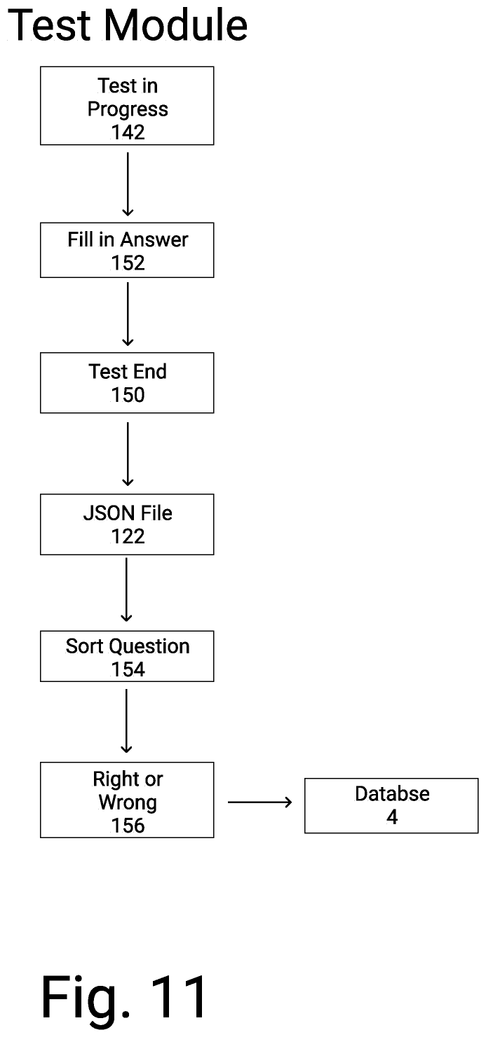

In one embodiment, FIG. 11 illustrates at least one sub-routine implemented on the present test and study administration and scantron analyzer (6). In this flow, the user has a Test in Progress (142). Once they Fill in Answer (152) with their stylus and the Test End (150) has happened the JSON File (122) is consulted where the questions go under Sort Question (154) where the main and subcategory are determined. Then it is determined whether the question was Right or Wrong (156), which is stored in the database (4).

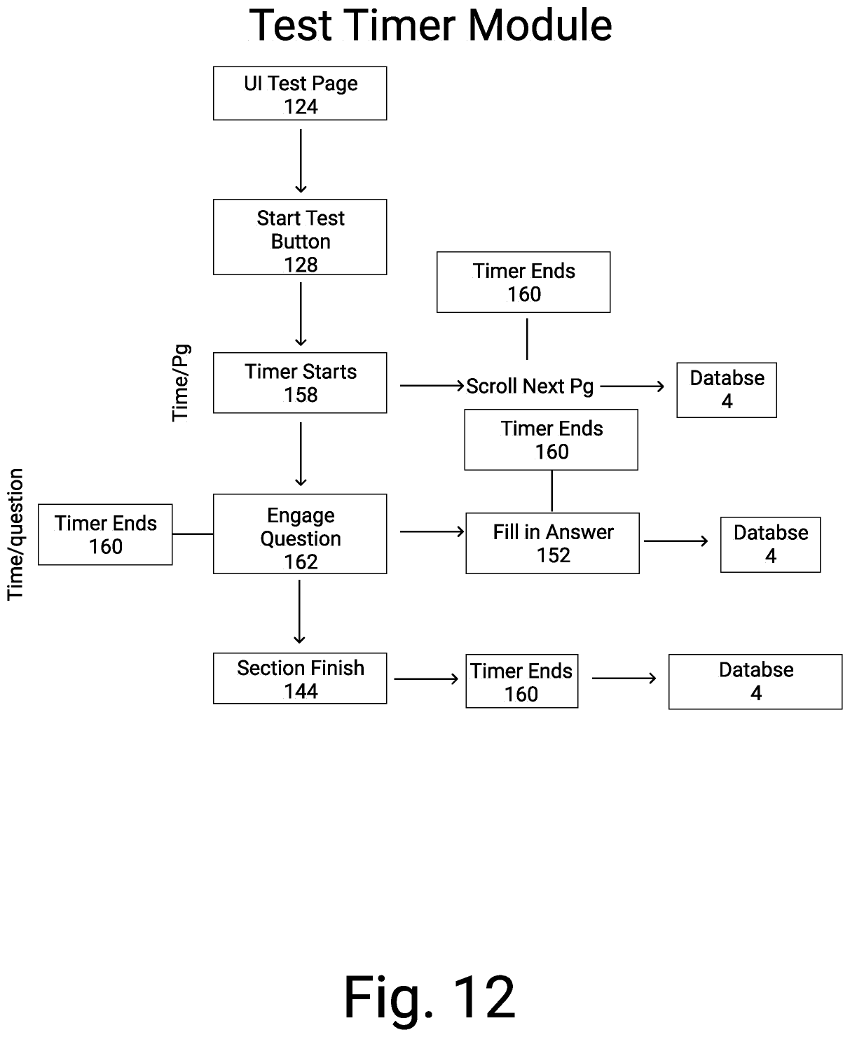

In one embodiment, FIG. 12 illustrates at least one sub-routine implemented on the present test and study administration system where the user is on UI Test Page (124) and press Start Test Button (128) and the Timer Starts (158). As the user scrolls to the next page that timer ends so the Timer Ends (160), sends the time per page to the Database (4). As a user Engages question (162) by writing on the question's designated area box that is drawn by a computer program, the Timer Starts (158). Once the user Fills in Answer (152) on the bubble sheet the Timer Ends (160) for that particular question. The time per question is sent to the database (4). This happens until the Section Finish (144) where the Timer Ends (160), measuring how long the entire section took, which is sent to the Database (4).

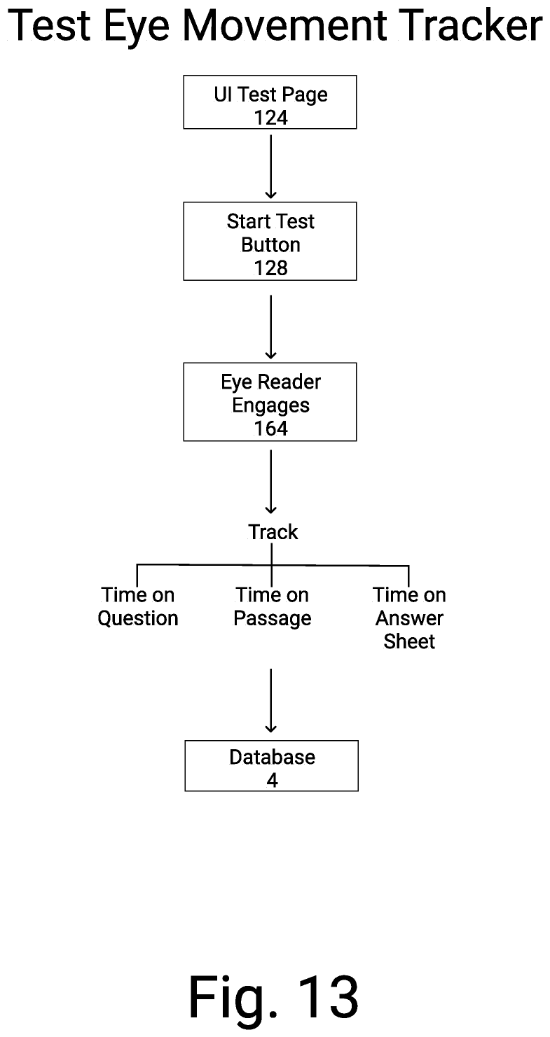

In one embodiment, FIG. 13 illustrates at least one sub-routine implemented on the present test and study administration showing an alternative way to track timing of the test via the eye movement Tracker (8). User is at UI Test Page (124) where they press Start Test Button (128), which makes Eye Reader Engages (164) start. This tracks the eye movement of time on question time on passage, time on answer sheet, time on instructions, etc. These measurements go to the Database (4). An app that represents this technology is available is Hawkeye Access™.

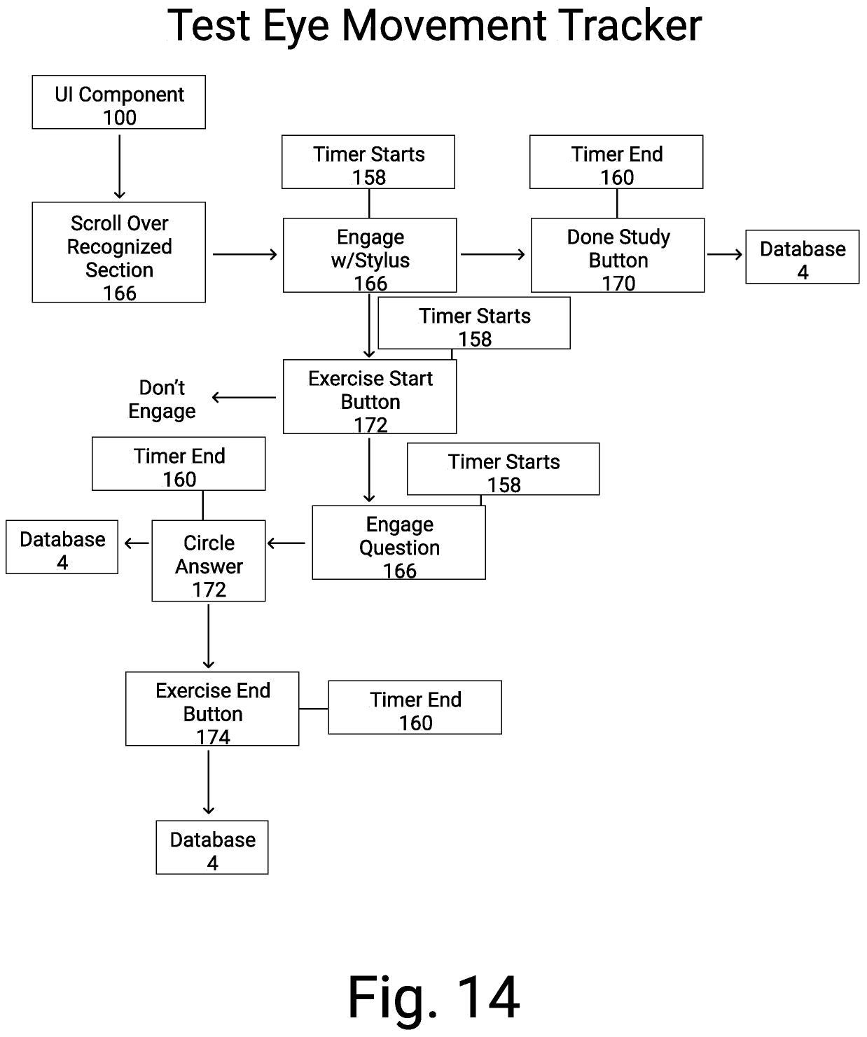

In one embodiment, FIG. 14 illustrates at least one sub-routine implemented on the present test and study administration where Study Timer Module (9) is used to measure time during study opposed to during tests. This shows their areas of learning in studying and is helpful data to compare to test performance. The user operates on the UI Component (100). They can Scroll over Recognized Section (166) and then Engage (168) so Timer Starts (158), until they press Done Study Button (170), prompting Timer End (160) sending the time of that study session to Database (4). If the user approaches an exercise they want to do and then they press Exercise Start Button (172) and Timer Starts (158), until they press exercise End Button (174) where the length of exercise is sent to Database (4). During the exercise when the user engages question (162) the Timer Starts (158), until they Circle Answer (172) and Timer Ends (160). The time per question in the exercise is sent to the Database (4).

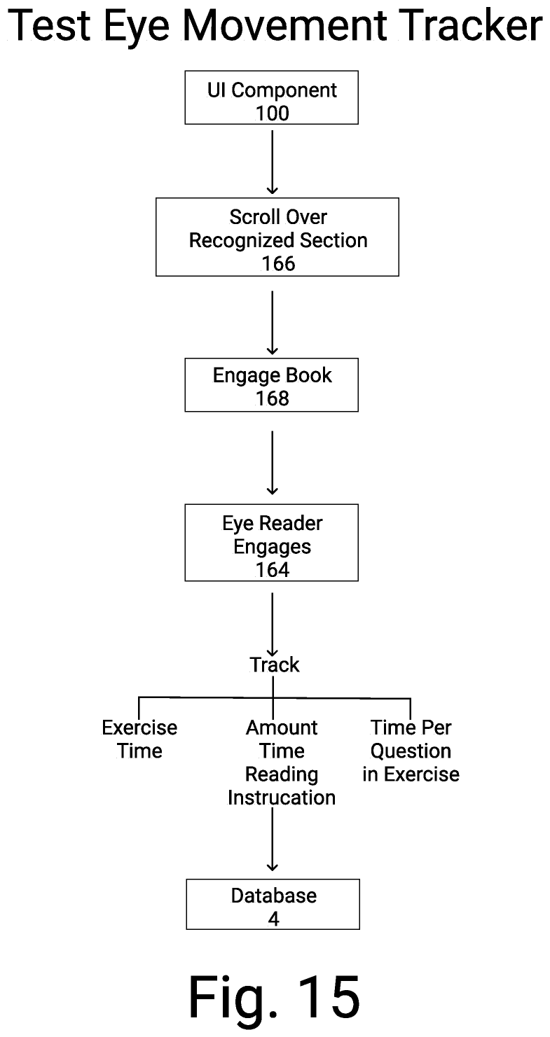

In one embodiment, FIG. 15 illustrates at least one sub-routine implemented on the present test and study administration for an alternative way to track timing of the Study that used eye movement Tracker (8). User can be on the UI Component (100). They Scroll over Recognized Section (166) and then Engage (168) so Eye Reader Engages (164). This tracks the eye movement of exercise time, amount of time reading instructions, time per question in exercise, time per exercise, how focused eyes are in exercise, etc.

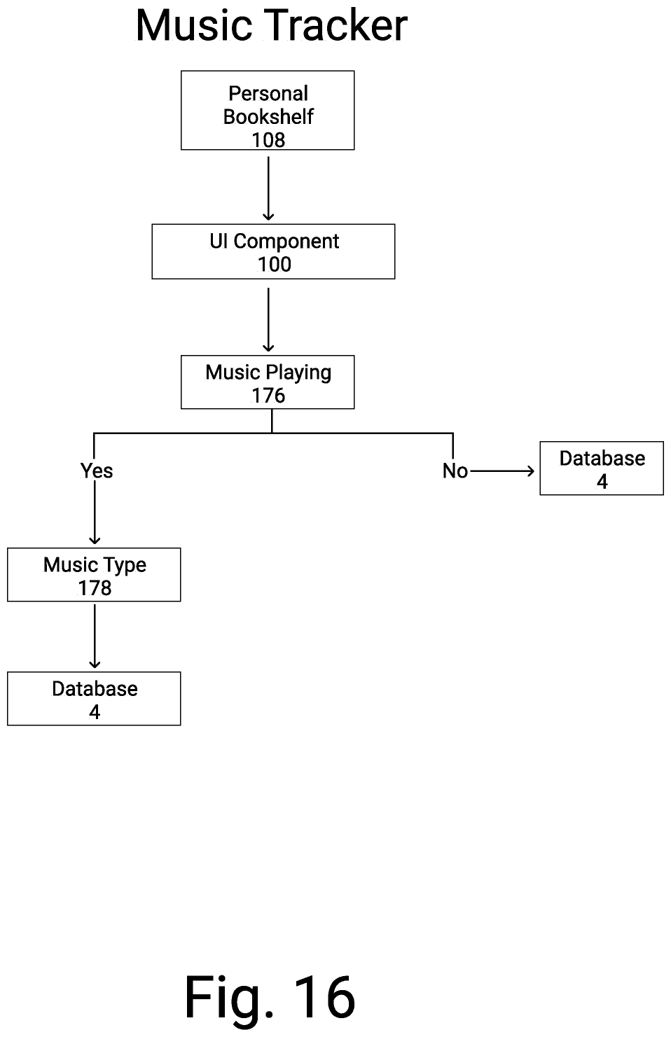

In one embodiment, FIG. 16 illustrates at least one sub-routine implemented on the present test and study administration where the user can start on Personal Bookshelf (108) and engage in Textbook to get UI Component (100). Music Playing (176) is either player yes or no. If not, it is sent to the Database (4) for the remainder of the study session. If yes, then Music Type (178) is sent to the Database (4). In the end it is able to track what type of music you do best with such as most correct sections, best performance by categories, etc.

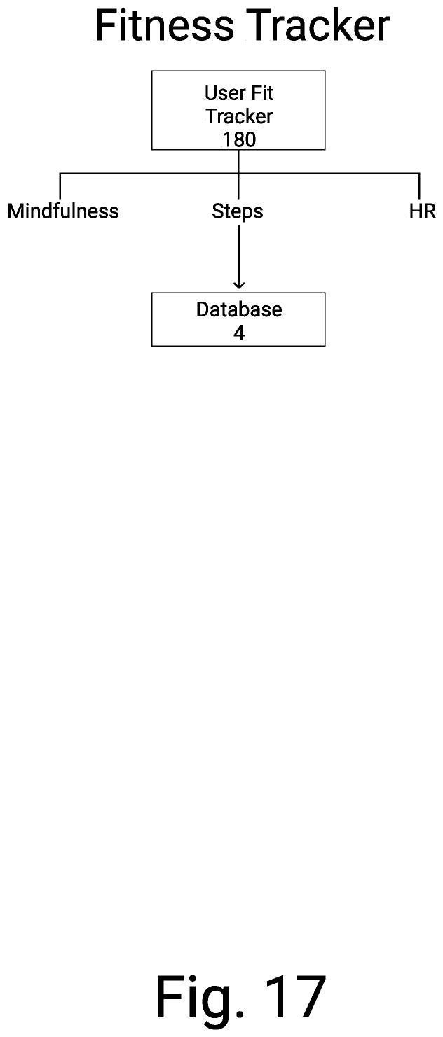

In one embodiment, FIG. 17 illustrates at least one sub-routine implemented on the present test and study administration where the User Fitness Tracker (180) tracks mindfulness, steps, and heart rate. Heart rate is tracked continuously throughout testing and linked with questions asked during such actions. This data is sent to the Database (4). This can be used to correlate how well study goes compared to your fitness statistics during that session.

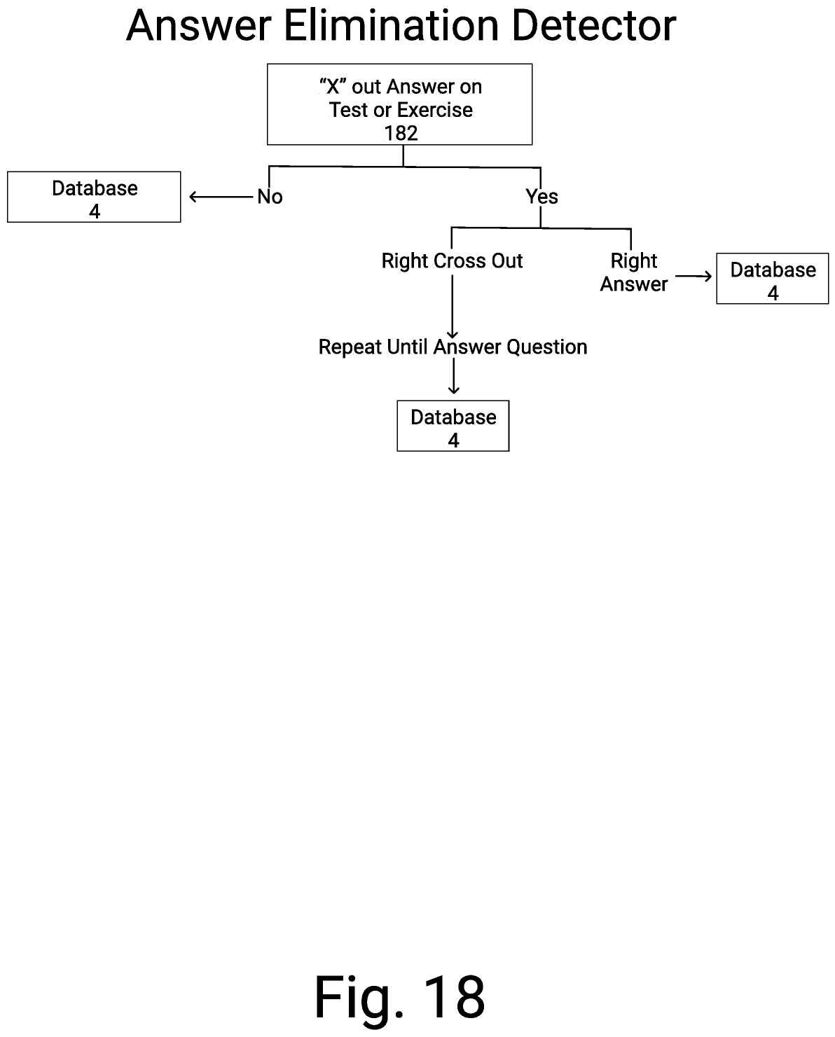

In one embodiment, FIG. 18 illustrates at least one sub-routine implemented on the present test and study administration where Answer Elimination Detector (13) is used to see the user's process through the test and how close they are to narrowing down to the right question. This information helps show whether or not a user was guessing on a question or not. User during test or study can “X” out certain multiple-choice questions. If he does not “X” out Answer (182) that is sent to the Database (4). If they do “X” out Answer (182) and it is the correct answer to the question, then that is sent to the Database (4). If they “X” out Answer (182) incorrect answer to the question, then this process is tracked until the question is answered and stored in the Database (4).

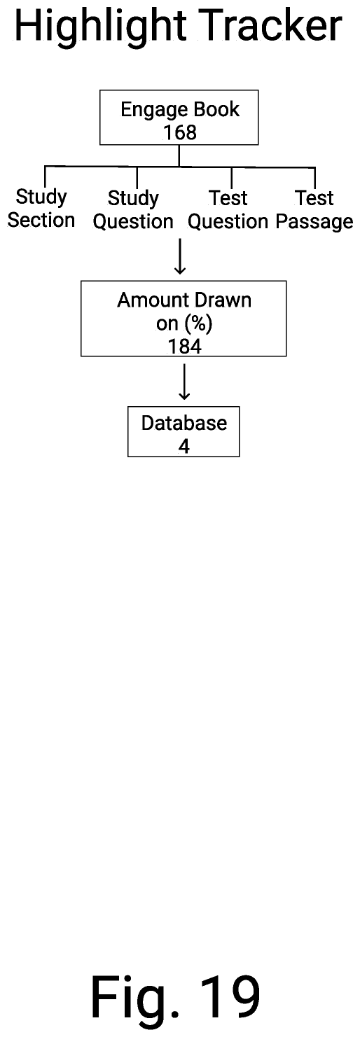

In one embodiment, FIG. 19 illustrates at least one sub-routine implemented on the present test and study administration implementing a User Engage (168) on a study section, study question, test question, or test passage, and the Amount Draw on (184) is stored in the Database (4). It is helpful to see whether or not users are performing better on questions that they write more on or not. This helps to see what the user's learning style is. For example, when a user takes these tests, by engaging with the question directly they can improve their score.

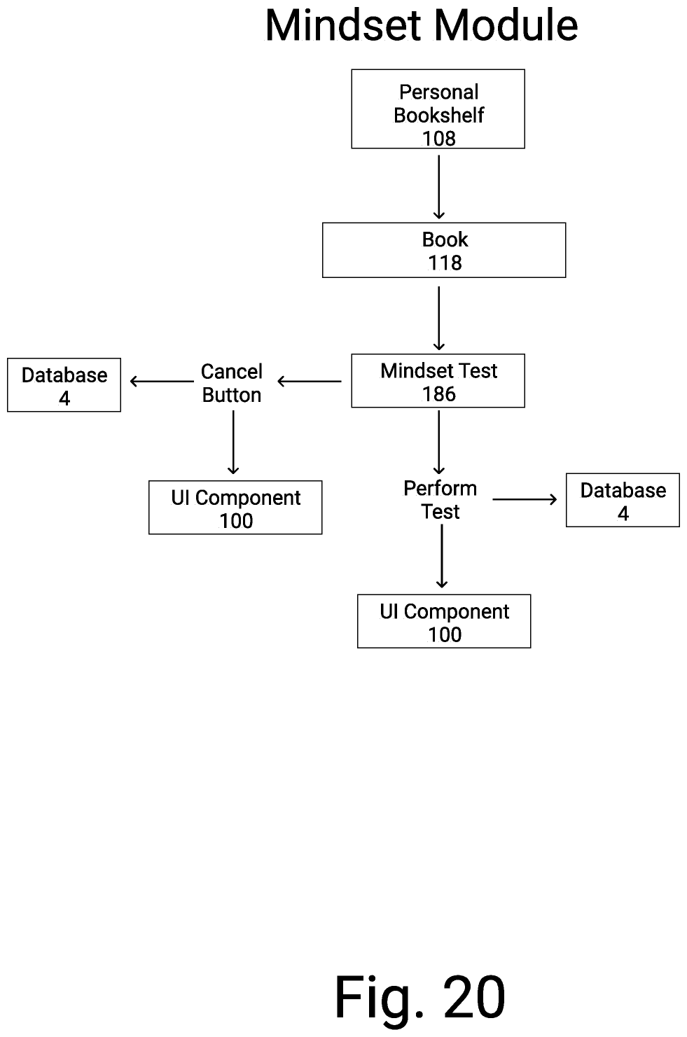

In one embodiment, FIG. 20 illustrates at least one sub-routine implemented on the present test and study administration where a user starts in Personal Bookshelf (108) and clicks on Book (118). They will be redirected to Mindset Test (186). They have the option to cancel the test and continue to UI Component (100) of the textbook, which is sent to the Database (4). The user can also perform the test, which is sent to the Database (4) and then they are redirected to the UI Component (100). The test includes questions about what they did before, how long they have worked that day, etc. These answers correlate with how well they do on their test or study. If it is seen that they are too stressed an intervention of their choosing may be selected.

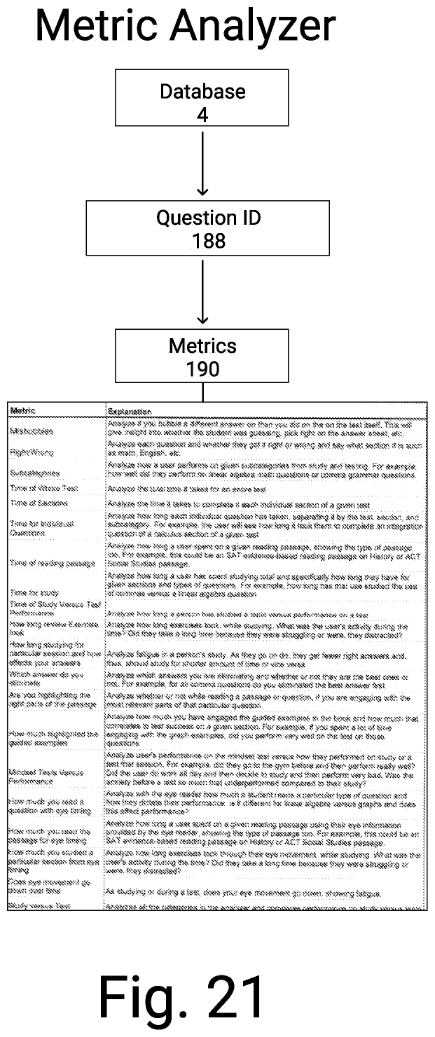

In one embodiment, FIG. 21 illustrates at least one sub-routine implemented on the present test and study administration where database (4) syncs with the Question ID (188) to create metrics (190) listed inside appendix.

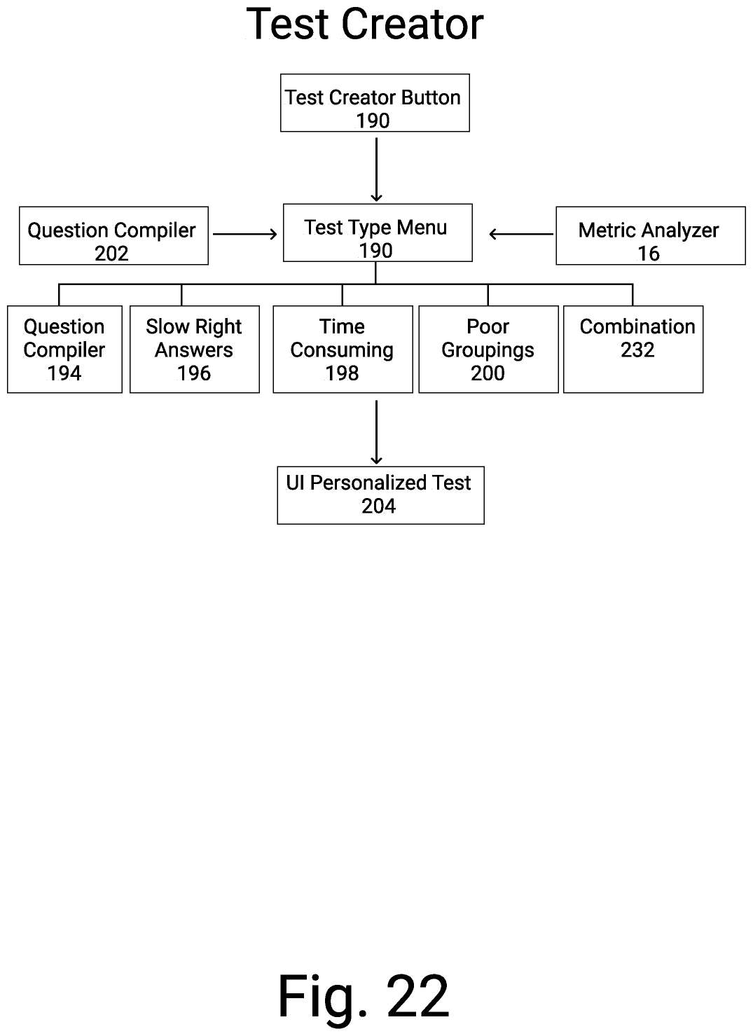

In one embodiment, FIG. 22 illustrates at least one sub-routine implemented on the present test and study administration where a user clicks on Test Creator Button (190) on the display, which redirects them to Test Type Menu (192). From this menu, the user has the option to choose a customized test made up of questions from the Question Compiler (202) where the test is made up on the person's personal profile based off their Metric Analyzer (16). The user gets a choice of personalized tests consisting of Question Compiler (202), taking from the other books on their Personal Bookshelf (108). After they pick one of these tests: Inverse Subject (194), Slow Right Answers (196), Time Consuming (198), Poor Groupings (200), and Combination (232), they are redirected to UI Personalized Test (204).

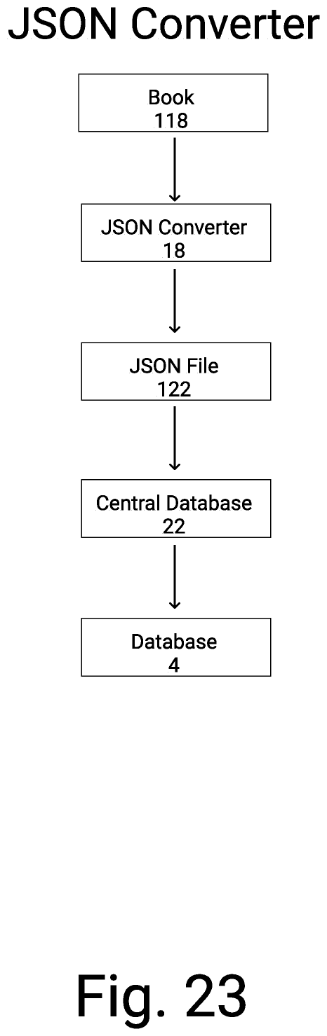

In one embodiment, FIG. 23 illustrates at least one sub-routine implemented on the present test and study administration where each Book (118) goes through the process of a JSON Converter (18), which creates a JSON File (122) that codifies all the information of a given test answers already in the book such as test type, correct answer, category, subcategory, and answer strength. For example, the JSON File (122) recognizes that the user is using a Princeton Review Book and have the information for each individual question throughout the book. The system knows that question 3 is in the math section, its subcategory is linear algebra, the answer is A, and it has the explanation. This also applies to general school textbooks. This file is stored in the Central Database (22), which is then sent to Database (4) of individual users.

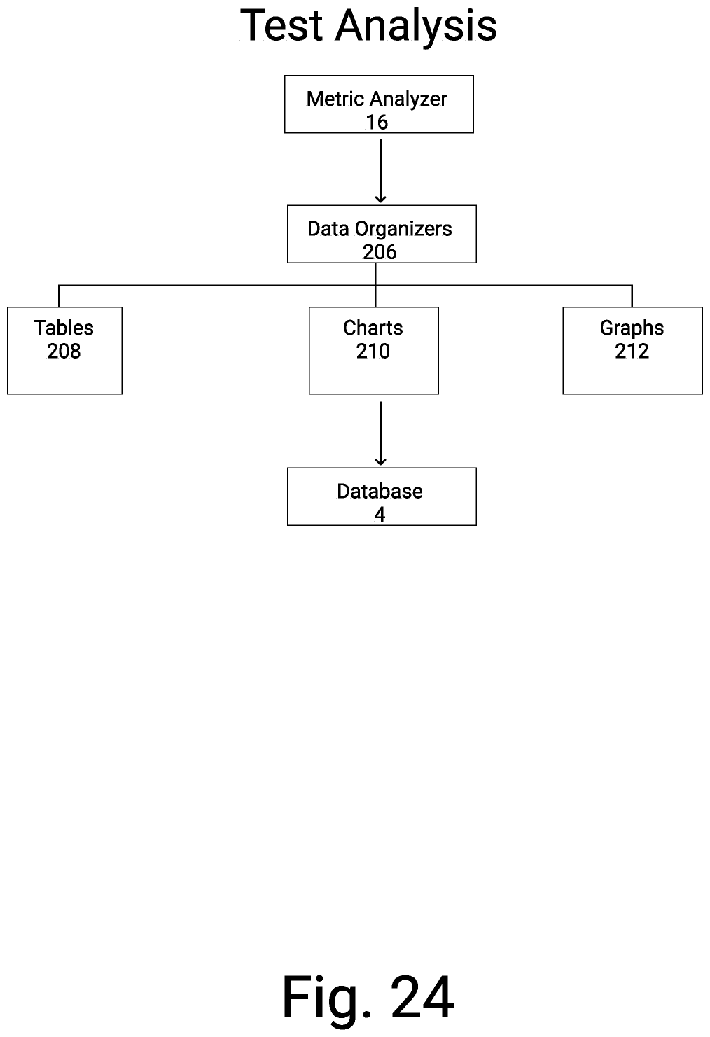

In one embodiment, FIG. 24 illustrates at least one sub-routine implemented on the present test and study administration system where Metric Analyzer (16) places into Data Organizer (206) where the device produces Tables (208), Charts (210), and Graphs (212) for the user to understand their test analysis better. These Tables (208), Charts (210), and Graphs (212) are sent to Database (4) to be accessed for later use.

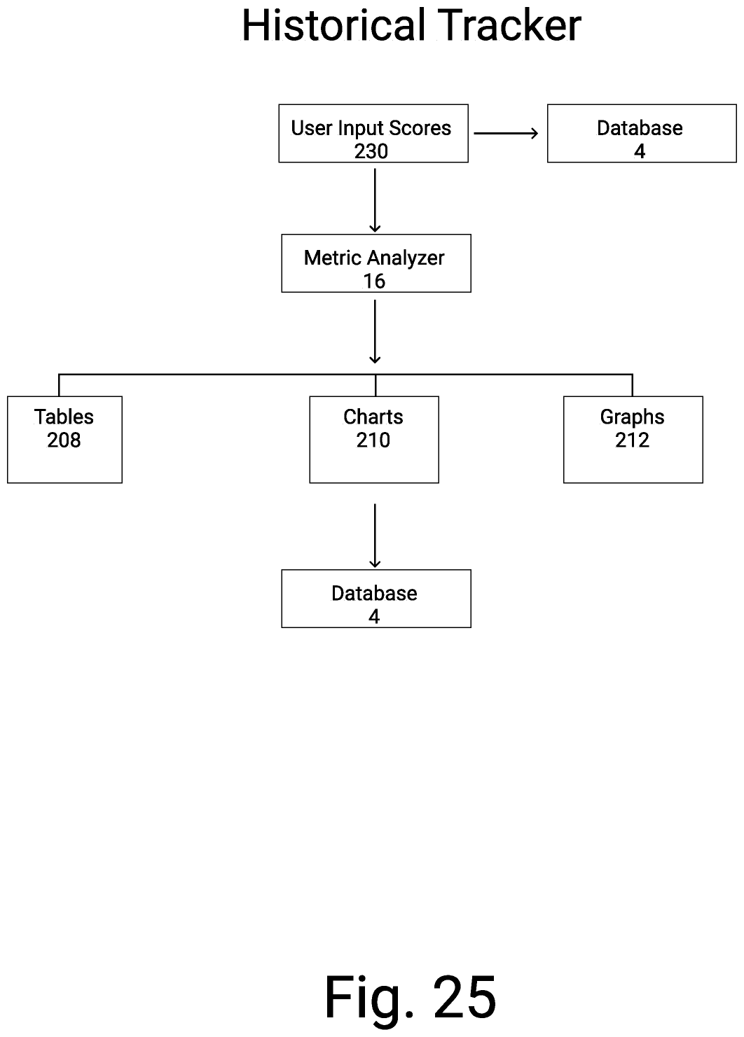

In one embodiment, FIG. 25 illustrates at least one sub-routine implemented on the present test and study administration system where Historical Tracker (25) predicts how people do historically based off their final scores and the data from their study. User Input Scores (230) is where the user adds their final score to Database (4). This goes to the Metric Analyzer (16) that produces Tables (208), Charts (210), and Graphs (212). These Tables (208), Charts (210), and Graphs (212) are sent to Database (4) to be accessed for later use.

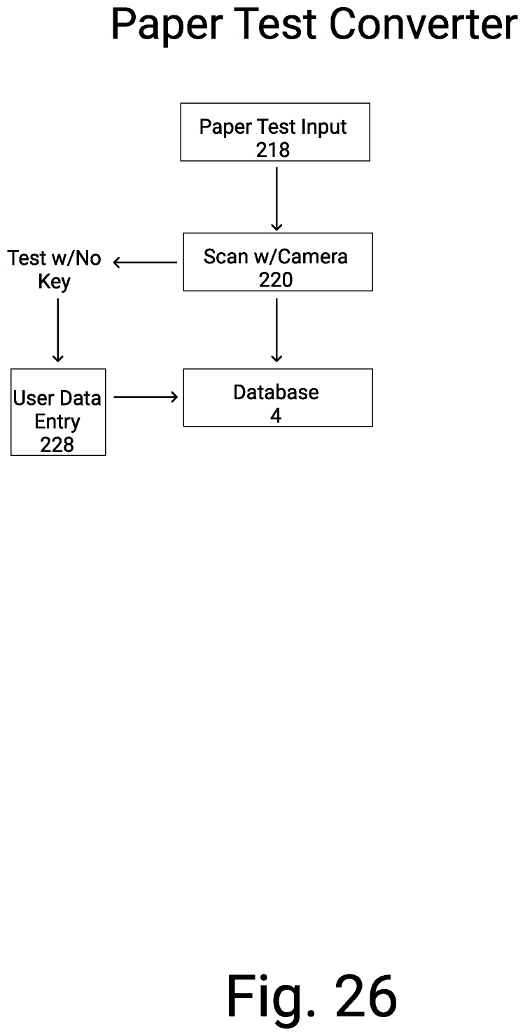

In one embodiment, FIG. 26 illustrates at least one sub-routine implemented on the present test and study administration system where Paper Test Input (218) is selected from either a test or results taken from an outside source. For example, the user could take a SAT practice test and scan in their bubble sheet, so the data is stored in Database (4). If the test data is not already in Database (4), the user uses the User Data Entry (228) to enter basic information about the test such as section, subcategory, and answer. The user scans with Camera (220) and the results go to Database (4).

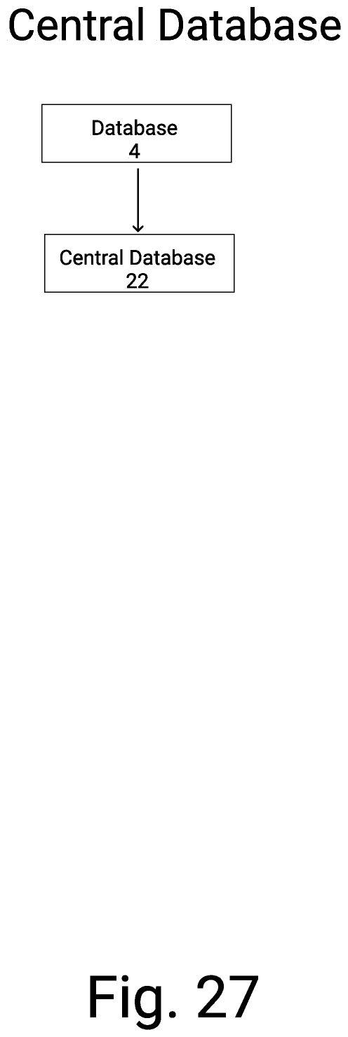

In one embodiment, FIG. 27 illustrates at least one sub-routine implemented on the present test and study administration system where Central Database (22) is implemented for storing all information. Database (4) can track individual users' information, which is then sent to Central Database (22). All bookkeeping function for the system can be handled from this storage location.

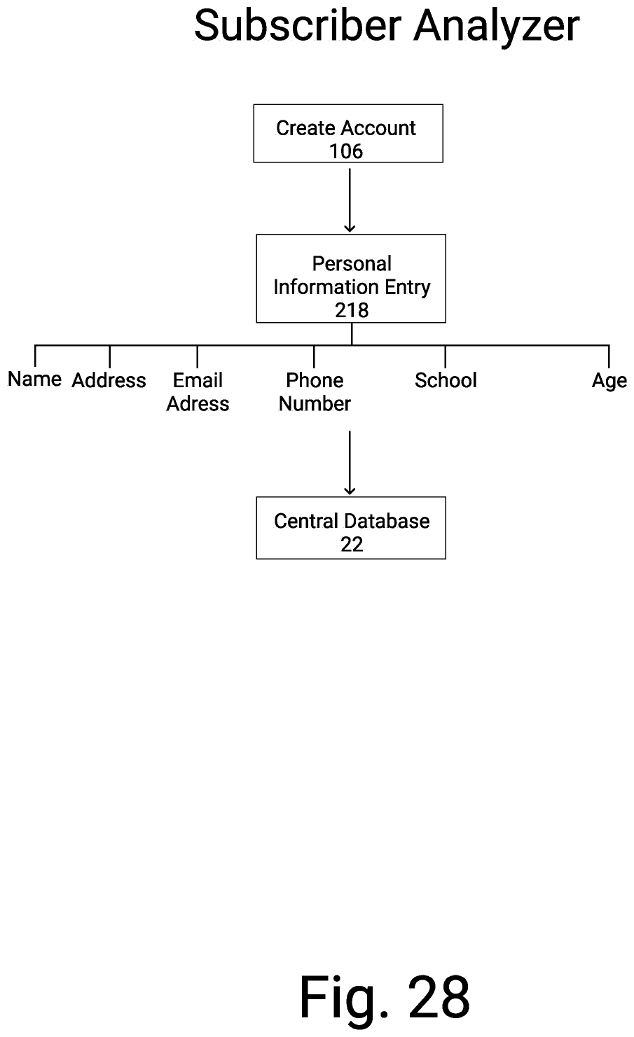

In one embodiment, FIG. 28 illustrates at least one sub-routine implemented on the present test and study administration system where, after filling out the Create Account (106) page, the user is promoted to the Personal Information entry (218). The use can fill out name, address, email address, phone number, school, and age. This information is sent to Central Database (22) so users' study and tests can be sorted.

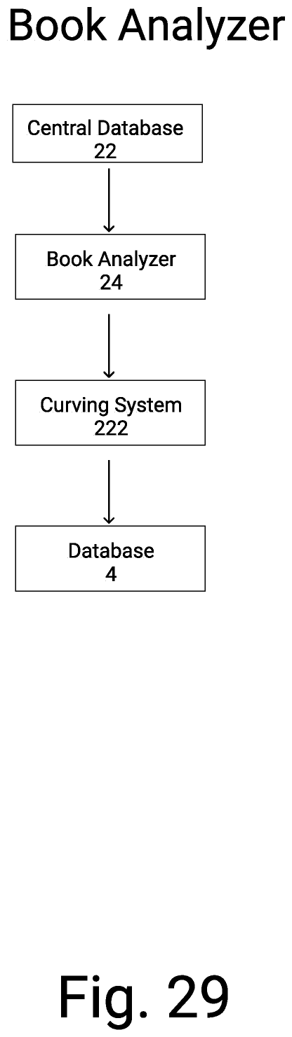

In one embodiment, FIG. 29 illustrates at least one sub-routine implemented on the present test and study administration system where Central Database (22) sends the scores from all different tests to Book Analyzer (24) where it creates a “True” curve of the test based on the scores from every test taken in the Curving System (220). This “True” curve is sent back to Database (4), so users can view the “True” Curve of each test from each book.

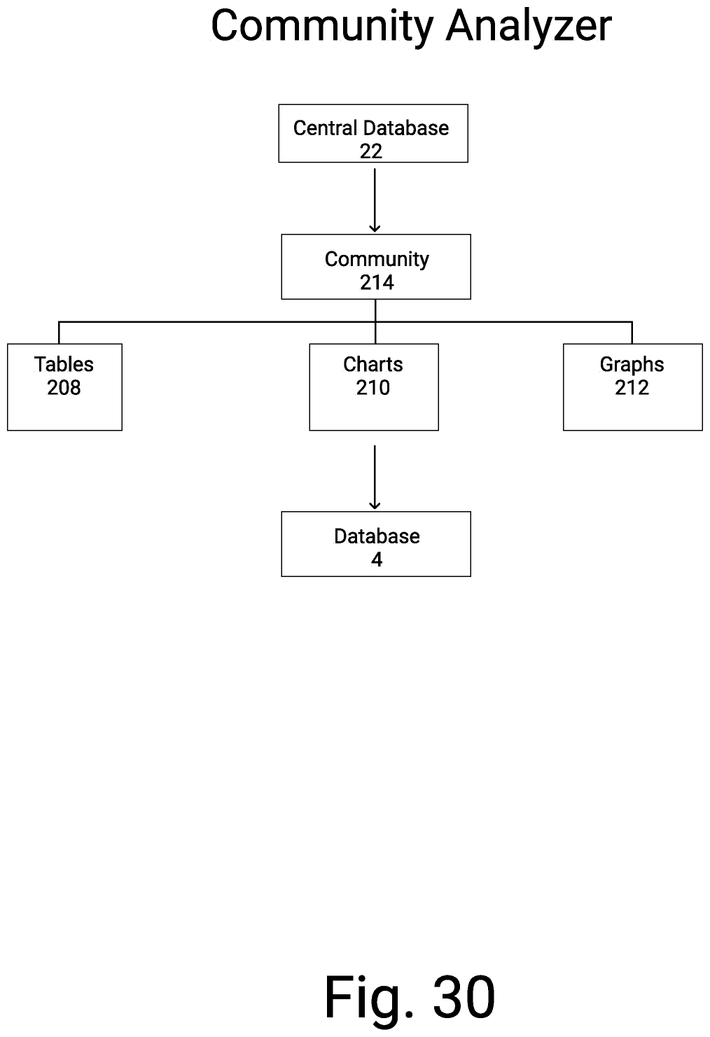

In one embodiment, FIG. 30 illustrates at least one sub-routine implemented on the present test and study administration system where, in conjunction with Community Analyzer (25), Central Database (22) uses the individual user's data to compile Community (214) statistics that represent the Metric Analyzer (16) statistics, but in this case for how the entire community did on the test. It includes the average scores, amount question got right, etc. It also takes the community metrics and represents how the community performed in that particular book, exercise, and test. This produces additional data for Tables (208), Charts (210), and Graphs (212), which is sent to User's Database (4).

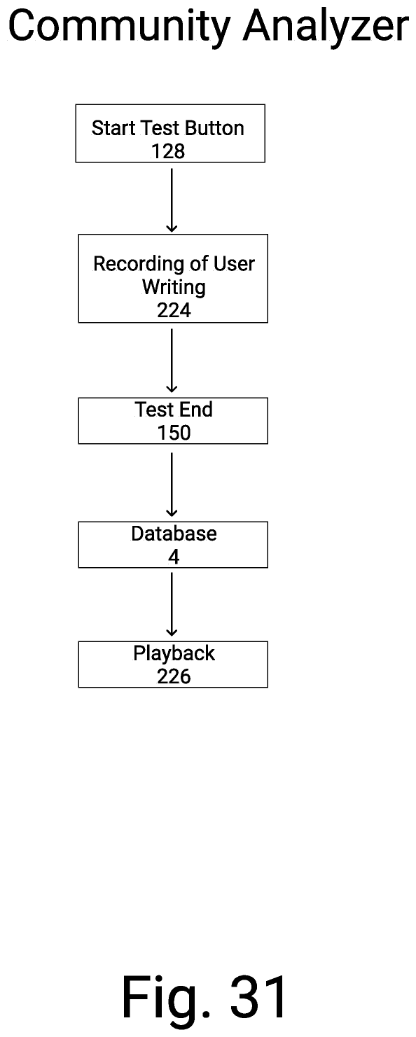

In one embodiment, FIG. 31 illustrates at least one sub-routine implemented on the present test and study administration system where, once the Start Test Button (128) on the display is pressed, the user's writing throughout the test is recorded with Recorder (224). At Test End (15) this recording is sent to Database (4), which saves the recording, allowing for a playback (224). The playback (226) may be implemented as a faint overlay on the test and then once the user wants to see their real time writing, they can tell the device to playback the recording.

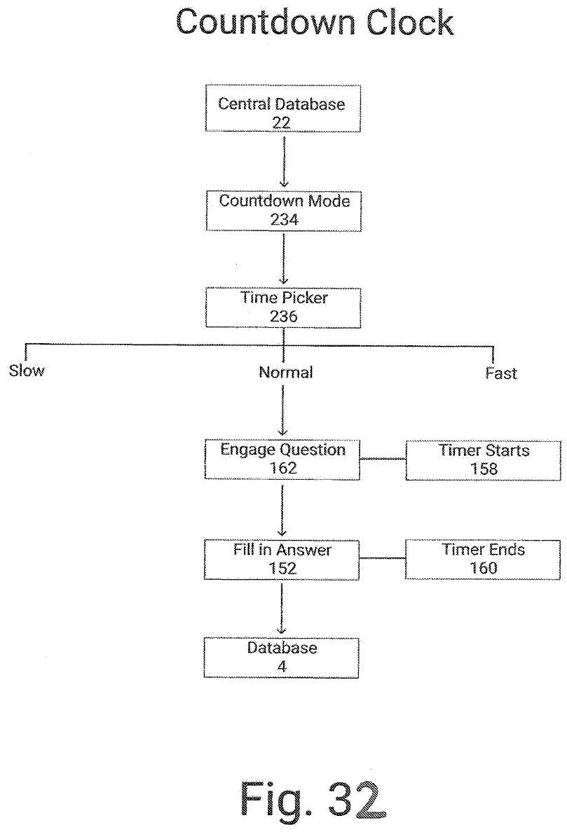

In one embodiment, FIG. 32 illustrates at least one sub-routine implemented on the present test and study administration system where Countdown Clock (32) serves to help a user's study by training them how long to take for a given question. From Central Database (22) the user can go to Countdown Mode (234) where they have the option of Time Picker (236). This sub-routine provides the user with three options: slow, normal, and fast. These times denote how long that they have for each question based off how other users performed on the same question. Then they can then Engage Question (162) so the Timer Starts (158) and, once they Fill in Answer (152), the Timer Ends (160). The data on correct or incorrect and time is sent to the Database (4).

While only certain features of the invention have been illustrated and described herein, many modifications, substitutions, changes or equivalents will now occur to those skilled in the art. It is therefore, to be understood that this application is intended to cover all such modifications and changes that fall within the true spirit of the invention.

What is claimed is:

1. A testing and study administration system for administering a test to a user comprising:
an input module, said input module configured to receive communications from the user for a test selection, and test answers from said user;
a central server, configured to store one or more available tests, and to administer said selected test among said one or more available tests to said user;
a computing device configured to monitor at least one behavior of said user, when taking said selected test, said computing device further configured to analyze said at least one monitored behavior and generate a feedback for said user; and
an output module said output module configured to provide said generated feedback to said user during continued administration of said selected test, said output module having a custom test generator that generates at least a second practice test with different questions than said selected test generated feedback.

2. The testing and study administration system as claimed in claim 1, wherein said computing device is configured to monitor a time for taking said test, including a time per question.

3. The testing and study administration system as claimed in claim 2, wherein said second practice test includes subjects where said user got test questions incorrect in said selected test.

4. The testing and study administration system as claimed in claim 3, wherein said second practice test includes subjects where said user got correct, but took over a preselected set time to answer, in said selected test.

5. The testing and study administration system as claimed in claim 2, wherein said computing device is configured to monitor eye movement of said user when taking said test, including eye movement per question.

6. The testing and study administration system as claimed in claim 5, wherein said second practice test includes subjects where said user got correct, but required excessive visual scanning, in said selected test.

7. The testing and study administration system as claimed in claim 2, wherein said computing device is configured to monitor music played by said user during said test.

8. The testing and study administration system as claimed in claim 2, wherein said computing device is configured to monitor fitness statistics of said user during said test.

9. The testing and study administration system as claimed in claim 2, wherein said computing device is configured to monitor partial answer elimination during said test.

10. The testing and study administration system as claimed in claim 9, wherein said second practice test includes subjects where said user partially eliminated answers, but left at least two un-eliminated, in said selected test, regardless of whether or not the question in said selected test was answered correctly or not.

11. The testing and study administration system as claimed in claim 2, wherein said computing device is configured to monitor highlighting of questions by said user during said test.

12. The testing and study administration system as claimed in claim 2, further comprises a metrics analyzer that said analyzes said at least one monitored behavior and generate a feedback for said users, based on said monitored behavior and the subject of said test questions during said test.
